(19) United States
(12) Patent Application Publication
(10) Pub. No.: US 2006/0212262 A1
(43) Pub. Date: Sep. 21, 2006

(54) Method and system for selecting one or more variables for use with a statiscal model

(76) Inventor: Glenn Stone, New South Wales (AU)

Correspondence Address: LADAS & PARRY LLP, 224 SOUTH MICHIGAN AVENUE, SUITE 1600, CHICAGO, IL, 60604, US

(21) Appl. No.: 10/564,937

(22) PCT Filed: Jul. 18, 2003
(86) PCT No.: PCT/AU03/00923

§ 371 Date: Apr. 3, 2006

(51) Int. Cl. G06F 17/18

(52) U.S. Cl. 702/179

(57) ABSTRACT

A method of selecting one or more variables for use with a statistical model, the method comprising the steps of: creating a plurality of unique subsets of variables of multivariate data; determining the performance of a discriminant rule when used with each of the subsets, the discriminant rule being based on multivariate normal class densities each having substantially diagonal covariance matrices; and selecting the one or more variables from at least one of the subsets that result in a desired performance of the discriminant rule.

### FIELD OF THE INVENTION

The present invention relates to a system and method for selecting one or more variables for use with a statistical model. The present invention is of particular, but by no means exclusive, application to building a classifier that is capable of predicting the class of an observation.

### BACKGROUND OF THE INVENTION

Generally speaking, a statistical model is a description of an assumed structure of a set of observations. Typically, the statistical model is in the form of a mathematical function of the process assumed to have generated the observations. The mathematical function is usually dependent on a number of variables that have been carefully selected to ensure the mathematical function accurately models the assumed process.

### SUMMARY OF THE INVENTION

According to a first aspect of the present invention, there is provided a method of selecting one or more variables for use with a statistical model, the method comprising the steps of:

creating a plurality of unique subsets of variables of multivariate data;

determining the performance of a discriminant rule when used with each of the subsets, the discriminant rule being based on multivariate normal class densities each having substantially diagonal covariance matrices; and

selecting the one or more variables from at least one of the subsets that result in a desired performance of the discriminant rule.

Given that the discriminant rule used in the method is widely considered to be suitable only for independent multinormal data, studies by the applicant have surprising shown that that method is in fact well suited to some data that is not independent multinormal, for example gene expression data.

Preferably, the step of creating the plurality of unique subsets comprises the step of identifying a variable in the multivariate data that is not a member of a set of variables, and adding the identified variable to the set.

This approach to creating the subsets is based on a forward stepwise variable selection technique.

Alternatively, the step of creating the plurality of unique subsets comprises the step of identifying a variable in the set which has not been previously removed, and removing the identified variable from the set.

This alternative approach is based on a backward stepwise variable selection technique.

Preferably, the step of determining the performance of the discriminant rule comprises assessing a prediction error rate of the discriminant rule.

Even more preferably, the prediction error rate is a cross-validated error rate.

Alternatively, the step of determining the performance of the discriminant rule is assessed using a likelihood based approach.

Preferably, the desired performance of the discriminant rule comprises the lowest possible prediction error rate of the discriminant rule.

Alternatively, the desired performance may be any other desired error rate.

Preferably, the multivariate data comprises gene expression data.

According to a second aspect of the present invention, there is provided computer software which, when executed by a computer, enables the computer to carry out the steps described in the first aspect of the present invention.

According to a third aspect of the present invention, there is provided a computer storage medium containing the software described in the second aspect of the present invention.

According to a fourth aspect of the present invention, there is provided a statistical model for predicting a class of an observation, wherein the model includes one or more variables that have been selected using the method described in the first aspect of the present invention.

According to a fifth aspect of the present invention, there is provided an apparatus for selecting one or more variables for use with a statistical model, the system comprising:

data creating means arranged to create a plurality of unique subsets of variables of multivariate data;

a processing means arranged to determine the performance of a discriminant rule when used with each of the subsets, the discriminant rule being based on multivariate normal class densities each having substantially diagonal covariance matrices; and

a selecting means arranged to select the one or more variables from at least one of the subsets that results in a desired performance of the discriminant rule.

Preferably, the data creating means is arranged to create the plurality of unique subsets by identifying a variable in the multivariate data that is not a member of a set of variables, and adding the identified variable to the set.

Alternatively, the data creating means is arranged to create the plurality of unique subsets by identifying a variable in the set which has not been previously removed, and removing the identified variable from the set.

Preferably, the determining means is arranged to determine the performance of the discriminant rule by assessing a prediction error rate of the discriminant rule.

Even more preferably, the prediction error rate is a cross-validated error rate.

Alternatively, the determining means is arranged to determine the performance of the discriminant rule using a likelihood based approach.

Preferably, the desired performance of the discriminant rule comprises the lowest possible prediction error rate of the discriminant rule.

Alternatively, the desired performance may be any other desired error rate.

Preferably, the multivariate data comprises gene expression data.

Preferably, the data creating means, processing means and selecting means are in the form of a computer running software.

### BRIEF DESCRIPTION OF THE DRAWINGS

Notwithstanding any other embodiments that may fall within the scope of the present invention, a preferred embodiment of the present invention will now be described, by way of example only, with reference to the accompanying figures, in which:

FIG. 1, illustrates a block diagram of the components that are included in an apparatus, according to the preferred embodiment of the present invention, that is arranged to select one or more variables for use with a statistical model; and

FIG. 2 illustrates a flow diagram of the various steps carried out by the apparatus of FIG. 1.

### A PREFERRED EMBODIMENT OF THE INVENTION

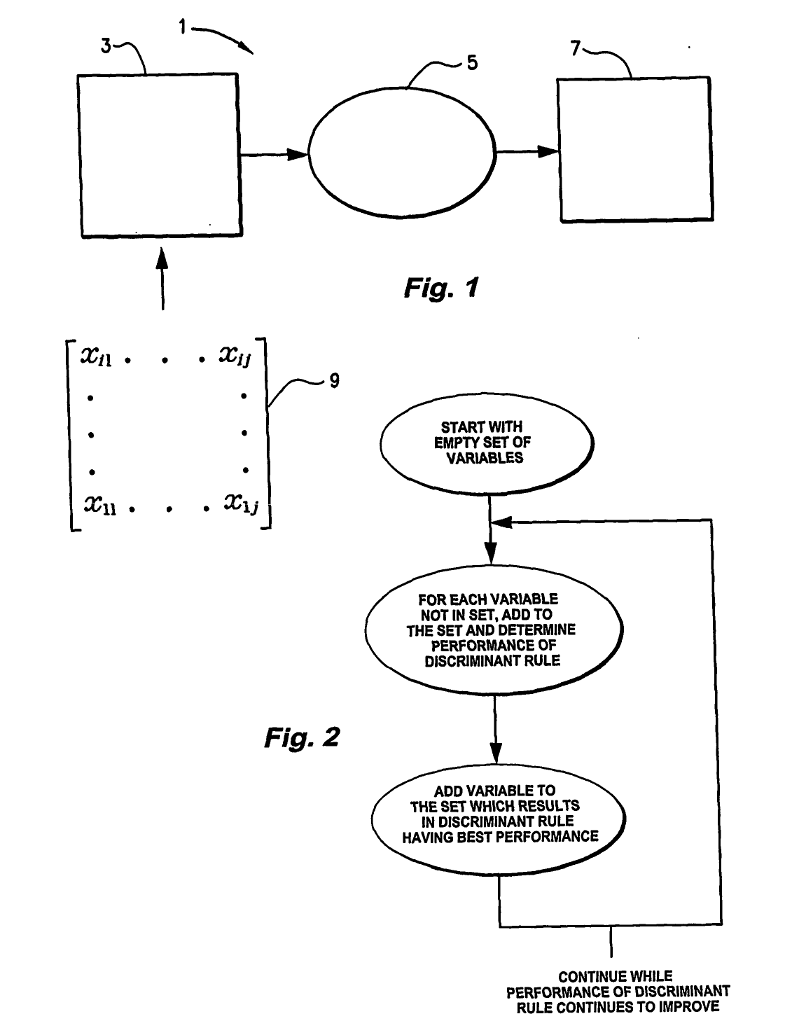

As can be seen in FIG. 1, an apparatus 1 according to the preferred embodiment of the present invention comprises data creating means 3, processing means 5, and selecting means 7. The data creating means 3, processing means 5 and selecting means 7 are in the form of a computer running software.

The data creating means 3 is arranged such that it has access to multivariate data 9; that is data for which each observation consists of values for more than one variable. In the preferred embodiment the multivariate data is gene expression data. An example of gene expression data is the leukemia data set referred to in the article entitled “Molecular classification of cancer: class discovery and class prediction by gene expression monitoring”, which appeared in Science 286:531-537, 1999.

The data creating means 3 processes the multivariate data 9 in order to produce a plurality of unique subsets of variables of the multivariate data 9.

Essentially, the data creating means 3 creates the plurality of unique subsets by employing a technique that is similar to forward stepwise variable selection. Generally speaking, forward stepwise selection involves identifying those variables in the multivariate data that are not in a set of variables which are ‘in a statistical model’, and adding them to the set one at a time. It is the process of adding the variables to the set that results in the creations of the plurality of unique subsets. Further details on the forward stepwise variable selection technique can be found in most texts covering discriminant function analysis. One such text can be found on the Internet at http://www.statsoftinc.com/textbook/stdiscan.html

Following the addition of a variable to the set, the processing means 5 applies the set (which is effectively one of the plurality of unique subsets) to a discriminant rule, and makes a record of the performance of the discriminant rule when used with the variables in the set. The processing means 5 continues this processes for each variable added to the set; that is, the processing means records the performance of the discriminant rule for each one of the unique subsets.

The discriminant rule used by the processing means 5 is based on multivariate normal class densities each having substantially diagonal covariance matrices, and is in the form of one of the following functions:

$$\begin{matrix}C ( x ) = arg {min}_{k} {\sum }_{j = 1}^{n} \{ \frac{{( {x}_{j} - {μ}_{kj} )}^{2}}{{σ}_{kj}^{2}} + log {σ}_{kj}^{2} \} & ( 1 ) \\ C ( x ) = arg {min}_{k} {\sum }_{j = 1}^{n} \frac{{( {x}_{j} - {μ}_{kj} )}^{2}}{{σ}_{kj}^{2}} & ( 2 )\end{matrix}$$

The first function (1) assumes that the class densities have diagonal covariance matrices, Δₖ=diag(σₖ₁², . . . , σₖₚ²), whilst the second function (2) assumes the class densities have the same diagonal covariance matrix, Δₖ=diag(σₗ², . . . , σₚ²).

In order to determine the performance of the discriminant rule, the processing means 5 is arranged to determine the cross-validated error rate of the predictor.

Once the processing means 5 has applied each of the unique subsets to the discriminant rule, the processing means 5 examines the recorded error rates to identify the subset that results in the lowest error rate. The processing means 5 then proceeds to select the one or more variables (for use with the statistical model) from the identified subset (that is, the subset that results in the lowest error rate) as the variables to be used with the statistical model.

The use of the forward stepwise technique means that the apparatus 1 is effectively performing the following steps:
1. Starting with an empty set of variables;
2. For each variable of the multivariate data not in the set, add to set and determine the performance of the discriminant rule;
3. Add variable to the set which results in the discriminant rule having the best performance; and
4. Continuing steps 1-3 while the performance of the discriminant rule is improving.

In order to select the one or more variables for use with the statistical model, the apparatus 1 is effectively carrying out the following broad steps:

creating a plurality of unique subsets of variables of multivariate data;

determining the performance of the discriminant rule when used with each of the subsets, the discriminant rule being based on multivariate normal class densities each having substantially diagonal covariance matrices; and

selecting the one or more variables from at least one of the subsets that result in a desired performance of the discriminant rule.

In order to gain an insight into the performance of the preferred embodiment of the present invention, the preferred embodiment was applied to Alizadeh's DLBECL data. The DLBCL data can be obtained from http://genome-www.stanfordd.edu/lymphoma. This data was collected from 42 patients and represents two classes of diffuse large B-cell lymphoma (DLBCL), GC and Activated. The preferred embodiment of the present invention selected just three genes (variables) from the DLBCL data. The three genes were then used in a classification which produced no errors (re-substitution), and when cross-validated the classifier produced about 5 errors (approximately 12%).

It is noted that whilst the preferred embodiment uses the cross-validated error rate as a measure of the discriminant rule's performance, other techniques for determining the performance of the discriminant rule are considered to be suitable. For example, a likelihood based approach.

Whilst the preferred embodiment employs a forward stepwise variable selection technique to create the plurality of unique subsets, it is envisaged that alternative techniques such a backward stepwise variable selection could be used with the present invention.

It will be appreciated that whilst the description of the preferred embodiment refers to the multivariate data as being gene expression data, the present invention can be used with multivariate data other that gene expression data.

Those skilled in the art will appreciate that the invention described herein is susceptible to variations and modifications other than those specifically described. It should be understood that the invention includes all such variations and modifications which fall within the spirit and scope of the invention.

1-16. (canceled)

17. A method of selecting one or more variables for use with a statistical model, the method comprising the steps of:
creating a plurality of unique subsets of variables of multivariate data;
determining the performance of a discriminant rule when used with each of the subsets, the discriminant rule being based on multivariate normal class densities each having substantially diagonal covariance matrices; and
selecting the one or more variables from at least one of the subsets that result in a desired performance of the discriminant rule.

18. The method as claimed in claim 17, wherein the step of creating the plurality of unique subsets comprises the step of identifying a variable in the multivariate data that is not a member of a set of variables, and adding the identified variable to the set.

19. The method as claimed in claim 17, wherein the step of determining the performance of the discriminant rule comprises assessing a prediction error rate of the discriminant rule.

20. The method as claimed in claim 19, wherein the prediction error rate is a cross-validated error rate.

21. The method as claimed in claim 17, wherein the desired performance of the discriminant rule comprises the lowest possible prediction error rate of the discriminant rule.

22. The method as claimed in claim 17, wherein the multivariate data comprises gene expression data.

23. Computer software which, when executed by a computer, enables the computer to carry out the method as claimed in claim 17.

24. A computer storage medium comprising the software as claimed in claim 23.

25. A statistical model for predicting a class of an observation, wherein the model includes one or more variables that have been selected using the method defined in claim 17.

26. An apparatus for selecting one or more variables for use with a statistical model, the system comprising:
data creating means arranged to create a plurality of unique subsets of variables of multivariate data;
a processing means arranged to determine the performance of a discriminant rule when used with each of the subsets, the discriminant rule being based on multivariate normal class densities each having substantially diagonal covariance matrices; and
a selecting means arranged to select the one or more variables from at least one of the subsets that results in a desired performance of the discriminant rule.

27. The apparatus as claimed in claim 26, wherein the data creating means is arranged to create the plurality of unique subsets by identifying a variable in the multivariate data that is not a member of a set of variables, and adding the identified variable to the set.

28. The apparatus as claimed in claim 26, wherein the determining means is arranged to determine the performance of the discriminant rule by assessing a prediction error rate of the discriminant rule.

29. The apparatus as claimed in claim 28, wherein the prediction error rate is a cross-validated error rate.

30. The apparatus as claimed in claim 26, wherein the desired performance of the discriminant rule comprises the lowest possible prediction error rate of the discriminant rule.

31. The apparatus as claimed in claim 26, wherein the multivariate data comprises gene expression data.

32. The apparatus as claimed in claim 26, wherein the data creating means, processing means and selecting means are in the form of a computer running software.
